(19) United States
(12) Patent Application Publication
(10) Pub. No.: US 2026/0224431 A1
(43) Pub. Date: Aug. 6, 2026

(54) WIRELESS BACK SCRATCHER AND TICKLER

(71) Applicant: DAVID ANDERSON, WARREN, NJ (US)

(72) Inventor: DAVID ANDERSON, WARREN, NJ (US)

(21) Appl. No.: 19/044,734

(22) Filed: Feb. 4, 2025

(51) Int. Cl. A61H 7/00

(52) U.S. Cl. CPC A61H 7/004; A61H 2201/1659; A61H 2201/5097; A61H 2203/0468; A61H 2205/081

(57) ABSTRACT

The wireless back scratcher and tickler may include a base, a rotating table, a plurality of articulated arms, control electronics, a battery, and an application program. The rotating table may be rotationally coupled to the base by a table motor. The plurality of articulated arms may be pivotably coupled to the rotating table. The base may be placed on a user's back and activated. The plurality of articulated arms may deploy and the rotating table may rotate such that arm attachments coupled to the distal ends of the plurality of articulated arms may move over the user's back. The wireless back scratcher and tickler may be controlled by the application program executing on a smart device.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of mechanically operated back-scratching device, more specifically, a wireless back scratcher and tickler.

### SUMMARY OF INVENTION

The wireless back scratcher and tickler may comprise a base, a rotating table, a plurality of articulated arms, control electronics, a battery, and an application program. The rotating table may be rotationally coupled to the base by a table motor. The plurality of articulated arms may be pivotably coupled to the rotating table. The base may be adapted to be placed on a user's back and activated. The plurality of articulated arms may deploy and the rotating table may rotate such that arm attachments coupled to the distal ends of the plurality of articulated arms may be adapted to move over the user's back. The wireless back scratcher and tickler may be controlled by the application program executing on a smart device.

An object of the invention is to provide a device that may be operable to tickle or scratch a user's back while resting on the user's back.

Another object of the invention is to provide a rotating table that rotates relative to a stationary base when driven by an energized table motor responsive to wireless digital messages from an application program executing on a smart device.

A further object of the invention is to provide a plurality of articulated arms that may pivot between a stowed position and a deployed position.

Yet another object of the invention is to provide an arm attachment that may detachably couple to the distal ends of the plurality of articulated arms and which may contact the user's back while the rotating table is rotating and the plurality of articulating arms are deployed.

These together with additional objects, features and advantages of the wireless back scratcher and tickler will be readily apparent to those of ordinary skill in the art upon reading the following detailed description of the presently preferred, but nonetheless illustrative, embodiments when taken in conjunction with the accompanying drawings.

In this respect, before explaining the current embodiments of the wireless back scratcher and tickler in detail, it is to be understood that the wireless back scratcher and tickler is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the wireless back scratcher and tickler.

It is therefore important that the claims be regarded as including such equivalent construction insofar as they do not depart from the spirit and scope of the wireless back scratcher and tickler. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a front view of an embodiment of the disclosure.

FIG. 2 is a top view of an embodiment of the disclosure.

FIG. 3 is an isometric view of an embodiment of the disclosure.

FIG. 4 is an in-use view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description. As used herein, the word “or” is intended to be inclusive.

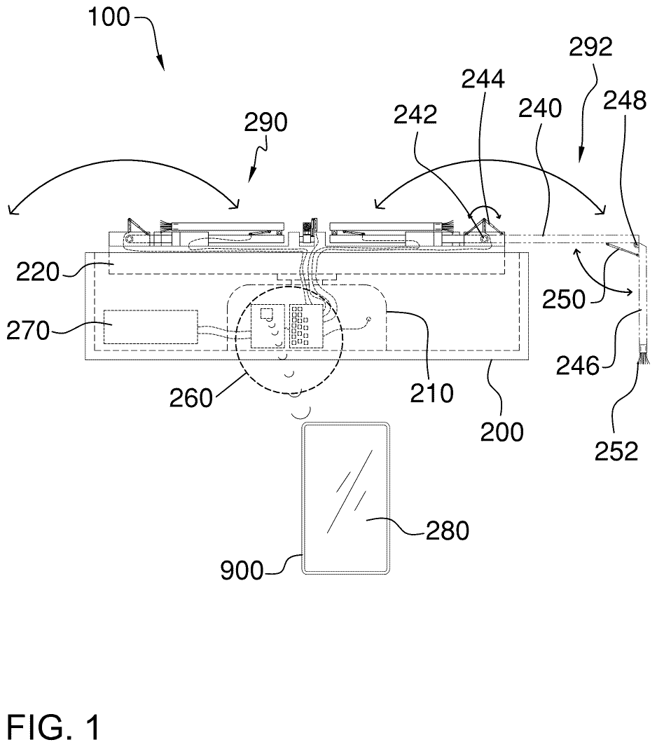

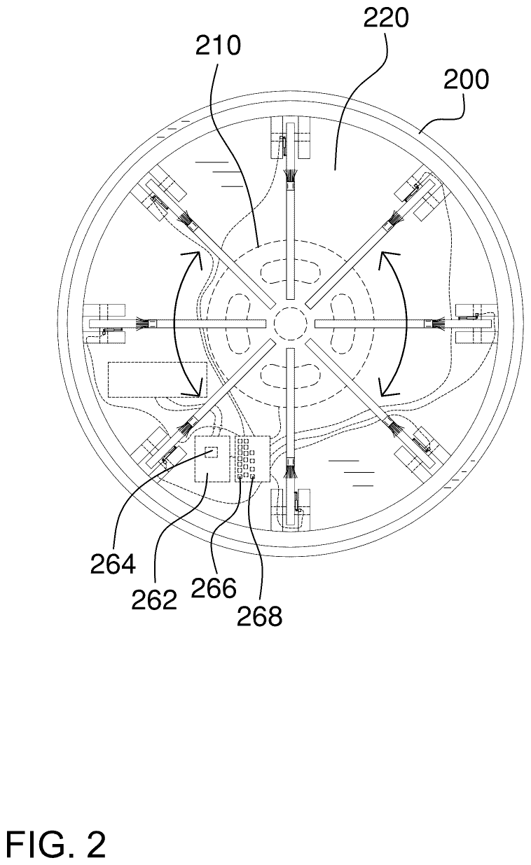

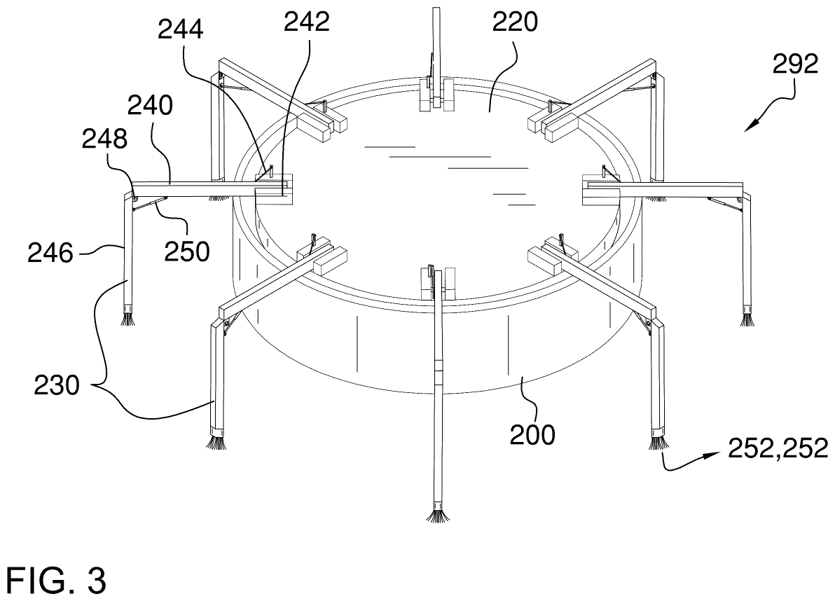

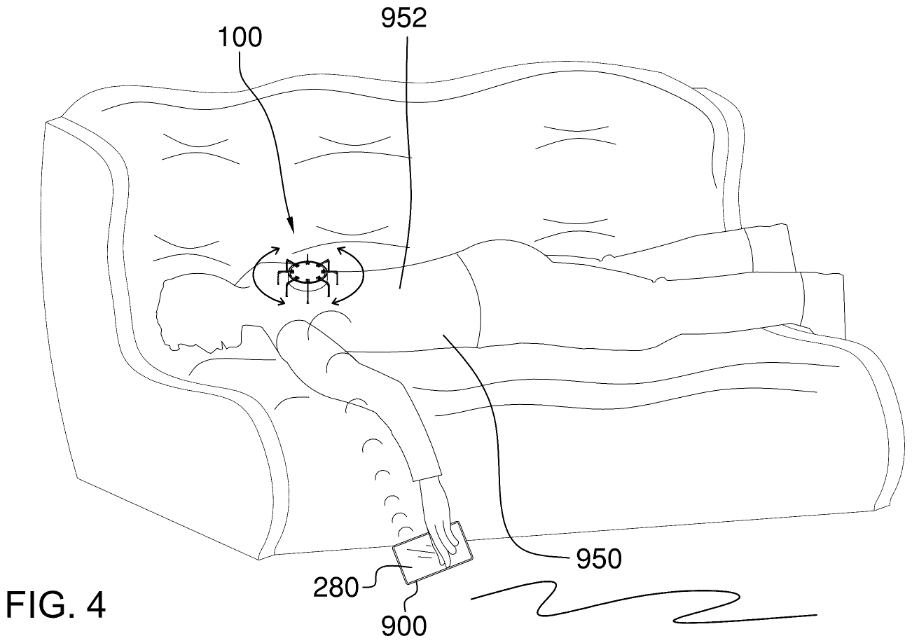

Detailed reference will now be made to a first potential embodiment of the disclosure, which is illustrated in FIGS. 1 through 4.

The wireless back scratcher and tickler 100 (hereinafter invention) comprises a base 200, a rotating table 220, a plurality of articulated arms 230, control electronics 260, a battery 270, and an application program 280. The rotating table 220 may be rotationally coupled to the base 200 by a table motor 210. The plurality of articulated arms 230 may be pivotably coupled to the rotating table 220. The base 200 may be adapted to be placed on a user's back 952 and activated. The plurality of articulated arms 230 may deploy and the rotating table 220 may rotate such that arm attachments 252 coupled to the distal ends of the plurality of articulated arms 230 may be adapted to move over the user's back 952. The invention 100 may be controlled by the application program 280 executing on a smart device 900.

The base 200 may be a cylindrical container. The table motor 210 may be coupled to the bottom interior of the base 200 with a shaft of the table motor 210 extends upwards to the rotating table 220. As a non-limiting example, the table motor 210 may be a stepper motor.

The rotating table 220 may be located at the top of the base 200. The rotating table 220 may rotate when the table motor 210 is energized. The plurality of articulated arms 230 may be coupled to a top surface of the rotating table 220.

An individual articulated arm selected from the plurality of articulated arms 230 may comprise a first arm segment 240 and a second arm segment 246. The proximal end of the first arm segment 240 may be coupled to the top surface of the rotating table 220 via a first arm hinge 242. The distal end of the first arm segment 240 may be coupled to the proximal end of the second arm segment 246 via a second arm hinge 248.

The individual articulated arm may be moved between a stowed position 290 and a deployed position 292. In the stowed position 290, the first arm segment 240 may be pivoted to be horizontal and to rest on the top surface of the rotating table 220 with the first arm hinge 242 adjacent to the center of the rotating table 220. In the stowed position 290, the second arm segment 246 may be pivoted to be horizontal and to rest on top of the first arm segment 240. In the deployed position 292, the first arm segment 240 may be pivoted to be horizontal and to extend away from the center of the rotating table 220 such that the first arm segment 240 overhangs the rotating table 220. In the deployed position 292, the second arm segment 246 may be pivoted to be vertical and to extend downward from the distal end of the first arm segment 240.

The first arm segment 240 may be pivoted between the stowed position 290 and the deployed position 292 by a first arm actuator 244. The first arm segment 240 may be pivoted between the stowed position 290 and the deployed position 292 by a second arm actuator 250. The first arm actuator 244 and the second arm actuator 250 may be controlled by the control electronics 260. The first arm actuator 244 and the second arm actuator 250 may be devices that may cause an armature to move relative to a pivot point. As non-limiting examples, the first arm actuator 244 and the second arm actuator 250 may be linear actuators.

The arm attachment 252 may detachably couple to the distal end of the second arm segment 246. The arm attachment 252 may be adapted to move over the user's back 952 when the plurality of articulated arms 230 are in the deployed position 292 and the table motor 210 is energized to turn the rotating table 220.

The arm attachment 252 may be selected from a plurality of arm attachments. As non-limiting examples, the plurality of arm attachments may comprise a tickling attachment 254 and a scratching attachment. The tickling attachment 254 may comprise a plurality of flexible fingers such that the tickling attachment 254 may be adapted to tickle the user's back 952. The scratching attachment may comprise a plurality of semi-rigid fingers such that the scratching attachment may be adapted to scratch the user's back 952.

In a preferred embodiment, there may be eight articulated arms.

The control electronics 260 may be adapted to control the operation of the table motor 210 and the plurality of articulated arms 230 as directed by a user 950. The control electronics 260 may comprise a microprocessor 262, a transceiver 264, a motor control circuit 266, and a plurality of actuator control circuits 268.

The microprocessor 262 may be a computer processor that incorporates the functions of a central processing unit in the form of one or more integrated circuits. The microprocessor 262 may be a multipurpose, clock driven, register based, digital-integrated circuit. The microprocessor 262 may accept binary data as input, may process the binary data according to instructions stored in memory contained within the microprocessor 262, and may provide results as output. The microprocessor 262 may contain both combinational logic and sequential digital logic. The microprocessor 262 may operate on numbers and symbols represented in the binary number system.

The transceiver 264 may be operable to wirelessly send and receive digital messages between the microprocessor 262 and the smart device 900. The digital messages may communicate operational commands from the smart device 900 to the microprocessor 262, status from the microprocessor 262 to the smart device 900, or both.

The motor control circuit 266 may control electrical signals that drive the table motor 210. The microprocessor 262 may command the motor control circuit 266 to start the table motor 210, stop the table motor 210, vary the rotational speed for the table motor 210, or any combination thereof.

The plurality of actuator control circuits 268 may control electrical signals that drive the first arm actuator 244 and the second arm actuator 250 on each of the plurality of articulated arms 230. The microprocessor 262 may command the plurality of actuator control circuits 268 to move the plurality of articulated arms 230 to the stowed position 290 and to the deployed position 292.

The battery 270 may comprise one or more energy-storage devices. The battery 270 may be a source of electrical energy to operate the control electronics 260, the motor control circuit 266, and the plurality of actuator control circuits 268. The battery 270 may be rechargeable and/or replaceable.

The application program 280 may execute on the smart device 900. The application program 280 may be adapted to provide the user 950 with a user interface that may control the operation of the invention 100, may provide status information regarding operation of the invention 100, or both.

In use, the user 950 may lay down in a prone position with the base 200 resting on the center of the user's back 952. Using the application program 280 executing on the smart device 900, the user 950 may activate the invention 100. Responsive to being activated, the microprocessor 262 may energize the table motor 210 to rotate the rotating table 220 and may move the plurality of articulated arms 230 from the stowed position 290 to the deployed position 292 such that the arm attachments 252 contact the user's back 952. As the rotating table 220 rotates, the arm attachments 252 may move across the user's back 952 providing the sensation of tickling, scratching, or massaging-depending upon which of the plurality of arm attachments are installed at the distal end of the plurality of articulated arms 230. When satisfied, the user 950 may deactivate the invention 100 using the application program 280. Responsive to being deactivated, the microprocessor 262 may deenergize the table motor 210 to stop rotation of the rotating table 220 and may move the plurality of articulated arms 230 from the deployed position 292 to the stowed position 290. As non-limiting examples, the smart device 900 may be a smartphone, a tablet computer, or a laptop computer

### Definitions

Unless otherwise stated, the words “up”, “down”, “top”, “bottom”, “upper”, and “lower” should be interpreted within a gravitational framework. “Down” is the direction that gravity would pull an object. “Up” is the opposite of “down”. “Bottom” is the part of an object that is down farther than any other part of the object. “Top” is the part of an object that is up farther than any other part of the object. “Upper” may refer to top and “lower” may refer to the bottom. As a non-limiting example, the upper end of a vertical shaft is the top end of the vertical shaft.

As used in this disclosure, an “application” or “app” may be software that is designed to perform one or more specific tasks on a personal computing device, smart phone, or some other computing device.

Throughout this document the terms “battery”, “battery pack”, and “batteries” may be used interchangeably to refer to one or more wet or dry cells or batteries of cells in which chemical energy is converted into electricity and used as a source of DC power. References to recharging or replacing batteries may refer to recharging or replacing individual cells, individual batteries of cells, or a package of multiple battery cells as is appropriate for any given battery technology that may be used. The battery may require electrical contacts which may not be illustrated in the figures.

As used herein, “between” may refer to a position bounded by two endpoints and, unless stated otherwise, may be inclusive of the endpoints. As used, herein, endpoints may comprise points on a line, lines within a plane, and planes within a three-dimensional space. “Move between” may refer to movement from a first endpoint to a second endpoint in either direction and specifically does not limit the direction of the movement.

As used herein, a control circuit may be an electrical circuit that manages and regulates the behavior or operation of a device.

As used herein, the words “couple”, “couples”, “coupled” or “coupling”, may refer to connecting, either directly or indirectly, and does not necessarily imply a mechanical connection.

As used herein, the words “data” and “information” may be used interchangeably to refer to raw, unprocessed facts and to facts that have been processed, structured, organized, or presented in a context that makes the facts useful.

As used herein, “deploy” may refer to configuring a device to place the device into service or to make the device ready for service. As non-limiting examples, “deployed” may be synonymous with extended, unfolded, inflated, erected, unwound, or activated. As non-limiting examples, a device that is not deployed may be referred to as retracted, folded, deflated, withdrawn, collapsed, stowed, wound, or deactivated.

As used in this disclosure, the terms “distal” and “proximal” may be used to describe relative positions. Distal refers to the object, or the end of an object, that is situated away from the point of origin, point of reference, or point of attachment. Proximal refers to an object, or end of an object, that is situated towards the point of origin, point of reference, or point of attachment. Distal implies ‘farther away from’ and proximal implies ‘closer to’. In some instances, the point of attachment may be the where an operator or user of the object makes contact with the object. In some instances, the point of origin or point of reference may be a center point, a central axis, or a centerline of an object and the direction of comparison may be in a radial or lateral direction.

As used herein, “energize” and/or “energization” may refer to the application of an electrical potential to a system or subsystem. “De-energize” and/or “de-energization” may refer to the removal of the electrical potential.

As used in this disclosure, “flexible” may refer to an object or material which will deform when a force is applied to it, which will not return to its original shape when the deforming force is removed, and which may not retain the deformed shape caused by the deforming force.

As used herein, “front” may indicate the side of an object that is closest to a forward direction of travel under normal use of the object or the side or part of an object that normally presents itself to view or that is normally used first. “Rear” or “back” may refer to the side that is opposite the front.

As used in this disclosure, a “hinge” may be a device that permits the turning, rotating, or pivoting of a first object relative to a second object.

As used in this disclosure, “horizontal” may be a directional term that refers to a direction that is perpendicular to the local force of gravity. Unless specifically noted in this disclosure, the horizontal direction is always perpendicular to the vertical direction.

As used in this disclosure, the word “interior” may be used as a relational term that implies that an object is located or contained within the boundary of a structure or a space.

As used in this disclosure, a “motor” may refer to a device that transforms energy from an external power source into mechanical energy.

As used herein, the word “pivot” may include any mechanical arrangement that allows for rotational motion. Non-limiting examples of pivots may include hinges, holes, posts, dowels, pins, points, rods, rivets, shafts, balls, and sockets, either individually or in combination.

As used herein, the terms “processor”, “central processor”, “central processing unit”, “CPU”, or “microprocessor” may refer to a digital device that carries out the instructions comprising a computer program by performing basic arithmetic, logical, control, and input/out operations. The term “microprocessor” may additionally imply a level of miniaturization and power reduction that makes the device suitable for portable or battery operated systems.

As used herein, “prone” may refer to a horizontal position where the dorsal side is up and the ventral side is down and “supine” may refer to a horizontal position where the dorsal side is down and the ventral side is up. As non-limiting examples, a person lying on their stomach is in a prone position and a person lying on their back is in a supine position.

As used herein, “resilient” or “semi-rigid” may refer to an object or material which may deform when a force is applied to it and which will return to its original shape when the deforming force is removed.

As used herein, “smart device” may refer to a portable electrical device comprising at least a processor, display, input device, and network connection. The input device is generally a touch screen, keyboard, or voice recognition. The network connection is generally wireless. Non-limiting examples of smart devices may include smartphones, tablets, personal digital assistants, laptop computers, and smartwatches. Smart devices may also be referred to as intelligent devices.

As used herein, “smart phone” or “smartphone” may refer to a personal communication device that incorporates cellular phone calling and texting capabilities along with advanced features. Non-limiting examples of the advanced features of a smart phone may include camera functions, multimedia functions (such as music and video recording and playback and gaming), internet functions (such as web browsing and file uploading/downloading), and Global Positioning System capabilities. A smartphone may be able to execute downloaded application programs that expand the capabilities of the smartphone.

As used in this disclosure, a “transceiver” may be a device that is used to transmit and/or receive signals. The signals may be audible, optical, or RF in nature.

As used in this disclosure, “vertical” may refer to a direction that is parallel to the local force of gravity. Unless specifically noted in this disclosure, the vertical direction is always perpendicular to horizontal.

As used in this disclosure, “wireless” may be an adjective that is used to describe a communication channel that does not require the use of physical cabling.

With respect to the above description, it is to be realized that the optimum dimensional relationship for the various components of the invention described above and in FIGS. 1 through 4, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A wireless back scratcher and tickler comprising:
a base, a rotating table, a plurality of articulated arms, control electronics, a battery, and an application program;
wherein the rotating table is rotationally coupled to the base by a table motor;
wherein the plurality of articulated arms are pivotably coupled to the rotating table;
wherein the base is adapted to be placed on a user's back and activated;
wherein the plurality of articulated arms deploy and the rotating table rotate such that arm attachments coupled to the distal ends of the plurality of articulated arms are adapted to move over the user's back;
wherein the wireless back scratcher and tickler is controlled by the application program executing on a smart device.

2. The wireless back scratcher and tickler according to claim 1
wherein the base is a cylindrical container;
wherein the table motor is coupled to the bottom interior of the base with a shaft of the table motor extends upwards to the rotating table.

3. The wireless back scratcher and tickler according to claim 2
wherein the table motor is a stepper motor.

4. The wireless back scratcher and tickler according to claim 2
wherein the rotating table is located at the top of the base;
wherein the rotating table rotates when the table motor is energized;
wherein the plurality of articulated arms are coupled to a top surface of the rotating table.

5. The wireless back scratcher and tickler according to claim 4
wherein an individual articulated arm selected from the plurality of articulated arms comprises a first arm segment and a second arm segment;
wherein the proximal end of the first arm segment is coupled to the top surface of the rotating table via a first arm hinge;
wherein the distal end of the first arm segment is coupled to the proximal end of the second arm segment via a second arm hinge.

6. The wireless back scratcher and tickler according to claim 5
wherein the individual articulated arm is moved between a stowed position and a deployed position;
wherein in the stowed position, the first arm segment is pivoted to be horizontal and to rest on the top surface of the rotating table with the first arm hinge adjacent to the center of the rotating table;
wherein in the stowed position, the second arm segment is pivoted to be horizontal and to rest on top of the first arm segment.

7. The wireless back scratcher and tickler according to claim 6
wherein in the deployed position, the first arm segment is pivoted to be horizontal and to extend away from the center of the rotating table such that the first arm segment overhangs the rotating table;
wherein in the deployed position, the second arm segment is pivoted to be vertical and to extend downward from the distal end of the first arm segment.

8. The wireless back scratcher and tickler according to claim 7
wherein the first arm segment is pivoted between the stowed position and the deployed position by a first arm actuator;
wherein the first arm segment is pivoted between the stowed position and the deployed position by a second arm actuator;
wherein the first arm actuator and the second arm actuator are controlled by the control electronics;
wherein the first arm actuator and the second arm actuator are devices that cause an armature to move relative to a pivot point.

9. The wireless back scratcher and tickler according to claim 8
wherein the first arm actuator and the second arm actuator are linear actuators.

10. The wireless back scratcher and tickler according to claim 8
wherein the arm attachment detachably couples to the distal end of the second arm segment;
wherein the arm attachment is adapted to move over the user's back when the plurality of articulated arms are in the deployed position and the table motor is energized to turn the rotating table.

11. The wireless back scratcher and tickler according to claim 10
wherein the arm attachment is selected from a plurality of arm attachments.

12. The wireless back scratcher and tickler according to claim 11
wherein the plurality of arm attachments comprise a tickling attachment and a scratching attachment;
wherein the tickling attachment comprises a plurality of flexible fingers such that the tickling attachment is adapted to tickle the user's back;
wherein the scratching attachment comprises a plurality of semi-rigid fingers such that the scratching attachment is adapted to scratch the user's back.

13. The wireless back scratcher and tickler according to claim 12
wherein there are eight articulated arms.

14. The wireless back scratcher and tickler according to claim 12
wherein the control electronics are adapted to control the operation of the table motor and the plurality of articulated arms as directed by a user;
wherein the control electronics comprises a microprocessor, a transceiver, a motor control circuit, and a plurality of actuator control circuits.

15. The wireless back scratcher and tickler according to claim 14
wherein the microprocessor is a computer processor that incorporates the functions of a central processing unit in the form of one or more integrated circuits;
wherein the microprocessor is a multipurpose, clock driven, register based, digital-integrated circuit;
wherein the microprocessor accepts binary data as input, processes the binary data according to instructions stored in memory contained within the microprocessor, and provides results as output;
wherein the microprocessor contains both combinational logic and sequential digital logic;
wherein the microprocessor operates on numbers and symbols represented in the binary number system.

16. The wireless back scratcher and tickler according to claim 14
wherein the transceiver is operable to wirelessly send and receive digital messages between the microprocessor and the smart device;
wherein the digital messages communicate operational commands from the smart device to the microprocessor, status from the microprocessor to the smart device, or both.

17. The wireless back scratcher and tickler according to claim 16
wherein the motor control circuit controls electrical signals that drive the table motor;
wherein the microprocessor commands the motor control circuit to start the table motor, stop the table motor, vary the rotational speed for the table motor, or any combination thereof.

18. The wireless back scratcher and tickler according to claim 17
wherein the plurality of actuator control circuits control electrical signals that drive the first arm actuator and the second arm actuator on each of the plurality of articulated arms;
wherein the microprocessor commands the plurality of actuator control circuits to move the plurality of articulated arms to the stowed position and to the deployed position.

19. The wireless back scratcher and tickler according to claim 18
wherein the battery comprises one or more energy-storage devices;
wherein the battery is a source of electrical energy to operate the control electronics, the motor control circuit, and the plurality of actuator control circuits;
wherein the battery is rechargeable and/or replaceable.

20. The wireless back scratcher and tickler according to claim 19
wherein the application program executes on the smart device;
wherein the application program is adapted to provide the user with a user interface that controls the operation of the wireless back scratcher and tickler, provides status information regarding operation of the wireless back scratcher and tickler, or both.
